(19) United States
(12) Patent Application Publication
(10) Pub. No.: US 2025/0296187 A1
(43) Pub. Date: Sep. 25, 2025

(54) CONTROL DEVICE OF MACHINE TOOL

(71) Applicant: FANUC CORPORATION, Minamitsuru-gun, Yamanashi (JP)

(72) Inventors: Yuutarou HORIKAWA, Yamanashi (JP); Masashi YASUDA, Yamanashi (JP)

(73) Assignee: FANUC CORPORATION, Minamitsuru-gun, Yamanashi (JP)

(21) Appl. No.: 18/860,890

(22) PCT Filed: May 13, 2022
(86) PCT No.: PCT/JP2022/020242

§ 371 Date: Oct. 28, 2024

(51) Int. Cl. B23Q 15/12

(52) U.S. Cl. CPC B23Q 15/12

(57) ABSTRACT

Provided is a technology with which it is possible to calculate surface roughness, and to easily set machining conditions and oscillation conditions while checking the calculated surface roughness. A control device 1 of a machine tool is for machining a workpiece while oscillating a cutting tool and the workpiece relative to each other, and comprises: a condition acquiring unit 12 that acquires machining conditions and oscillation conditions; a surface roughness calculation unit 13 that calculates surface roughness on the basis of the machining conditions and oscillation conditions acquired by the condition acquiring unit 12; and a surface roughness output unit 14 that outputs the surface roughness calculated by the surface roughness calculation unit 13.

### TECHNICAL FIELD

The present disclosure relates to a control device for machine tools.

### BACKGROUND ART

Conventionally, oscillation cutting is known in which a workpiece is machined by cutting while a cutting tool and the workpiece are relatively oscillated in order to prevent chips continuously generated during cutting from becoming entangled with the workpiece or the cutting tool, which can cause defects or machine failures. In the oscillation cutting, the oscillation frequency and the oscillation amplitude are adjusted, whereby the tool route as the path of the cutting tool is set to partially overlap the previous tool route. As a result, an air cut occurs, where the cutting edge of the cutting tool moves away from the surface of the workpiece, whereby the chips are shredded.

However, the surface roughness of a workpiece machined by oscillation cutting tends to deteriorate, as compared to the case without oscillation cutting. This is because the route of the cutting tool by oscillation cutting is the path of the oscillation operation conforming to the specified oscillation conditions. Therefore, a technique has been proposed to calculate the surface roughness, based on factors such as the shape of the cutting edge of the cutting tool, the rotation speed and the feed rate of the spindle (see, for example, Patent Document 1).

### CITATION LIST

### Patent Document

Patent Document 1: Japanese Unexamined Patent Application, Publication No. 2020-114614

### DISCLOSURE OF THE INVENTION

### Problems to be Solved by the Invention

However, since the calculation of surface roughness depends on the machining conditions and oscillation conditions, it has been difficult to set the machining conditions and oscillation conditions while considering the surface roughness. Accordingly, there is a need for a technique capable of calculating the surface roughness and easily setting the machining conditions and oscillation conditions while verifying the calculated surface roughness.

The present disclosure has been made in view of the above problems, and an object thereof is to provide a technique capable of calculating the surface roughness and easily setting the machining conditions and oscillation conditions while verifying the calculated surface roughness.

### Means for Solving the Problems

The present disclosure provides a control device for a machine tool that machines a workpiece while relatively oscillating the cutting tool and the workpiece. The control device includes: a condition acquisition unit that acquires machining conditions and oscillation conditions; a surface roughness calculation unit that calculates a surface roughness, based on the machining conditions and the oscillation conditions acquired by the condition acquisition unit; and a surface roughness output unit that outputs the surface roughness calculated by the surface roughness calculation unit.

### Effects of the Invention

According to the present disclosure, it is possible to provide a technique capable of calculating a surface roughness and easily setting machining conditions and oscillation conditions while verifying the calculated surface roughness.

### BRIEF DESCRIPTION OF THE DRAWINGS

FIG. 1 is a diagram illustrating oscillation cutting;

FIG. 2 is a functional block diagram of a machine tool control device according to the first embodiment;

FIG. 3 is a diagram illustrating a surface roughness confirmation screen where machining conditions and oscillation conditions have been input;

FIG. 4 is a diagram illustrating a cutting path;

FIG. 5 is a diagram illustrating a surface roughness confirmation screen displaying the calculated surface roughness;

FIG. 6 is a diagram illustrating the phase for obtaining the roughness curve;

FIG. 7 is a diagram illustrating the roughness curve;

FIG. 8 is a functional block diagram of a machine tool control device according to the second embodiment;

FIG. 9 is a diagram illustrating the first example of a surface roughness correction table;

FIG. 10 is a diagram illustrating the first example of the surface roughness correction table;

FIG. 11 is a diagram illustrating a surface roughness confirmation screen displaying the calculated surface roughness;

FIG. 12 is a diagram illustrating a surface roughness confirmation screen displaying the surface roughness corrected based on the surface roughness correction coefficient;

FIG. 13 is a diagram illustrating the second example of the surface roughness correction table;

FIG. 14 is a diagram illustrating the second example of the surface roughness correction table;

FIG. 15 is a diagram illustrating a surface roughness confirmation screen displaying the calculated surface roughness;

FIG. 16 is a diagram illustrating a surface roughness confirmation screen displaying the surface roughness corrected for each type of workpiece;

FIG. 17 is a functional block diagram of a machine tool control device according to the third embodiment;

FIG. 18 is a diagram illustrating the attenuation rate of the actual measured value against the command value of the oscillation amplitude;

FIG. 19 is a diagram illustrating a surface roughness confirmation screen where the attenuation rate of the oscillation amplitude has been input; and

FIG. 20 is a diagram illustrating a surface roughness confirmation screen displaying the surface roughness corrected based on the attenuation rate of the oscillation amplitude.

### PREFERRED MODE FOR CARRYING OUT THE INVENTION

Hereinafter, the embodiments of the present disclosure will be described in detail with reference to the drawings. In the descriptions of the second and subsequent embodiments, components common to the first embodiment are denoted by the same reference numerals, and their descriptions are omitted as appropriate.

### First Embodiment

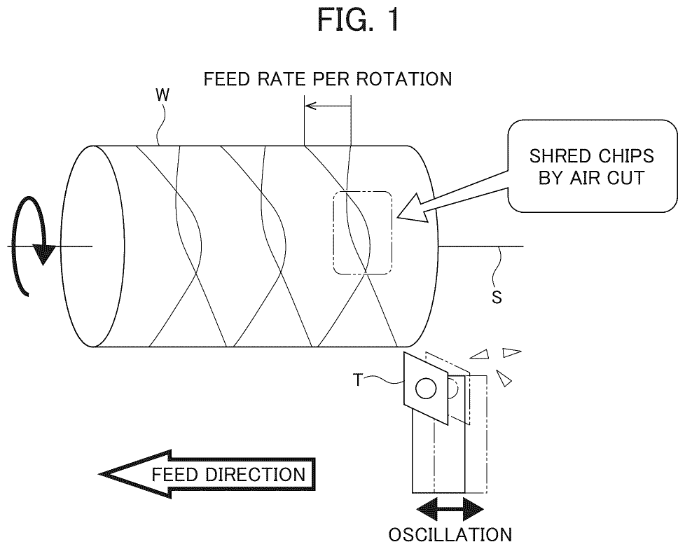

The machine tool control device according to the first embodiment performs oscillation cutting, in which a workpiece is machined by cutting while the cutting tool and the workpiece are relatively oscillated. FIG. 1 is a diagram illustrating oscillation cutting. In the example of oscillation cutting illustrated in FIG. 1, at least one spindle S that relatively rotates the cutting tool T and the workpiece W, and at least one feed shaft (not illustrated) that relatively moves the cutting tool T relative to the workpiece W, are operated to relatively rotate the cutting tool T and the workpiece W, while oscillating the cutting tool T and the workpiece W in the feed direction during cutting machining. In this case, the tool route as the path of the cutting tool T is set such that the current route partially overlap the previous route. Since the current route partially includes the machined portion in the previous route, an air cut occurs such that the cutting edge of the cutting tool T moves away from the surface of the workpiece W, thereby shredding the chips.

In the oscillation cutting executed in the present embodiment, the shape of the workpiece is not limited. That is, the present embodiment can be applied to the cases where a plurality of feed shafts (Z-axis and X-axis) are required since the workpiece includes taper portions or arc portions on the machining surface, or the cases where one specific feed shaft (Z-axis) is sufficient since the workpiece is columnar or cylindrical.

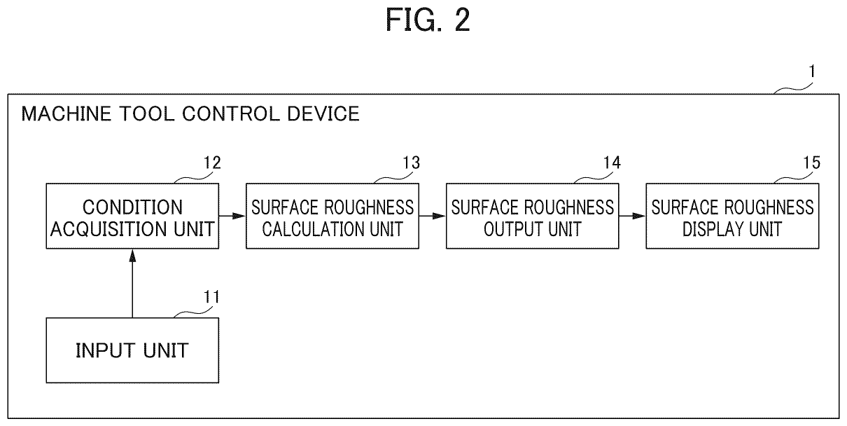

FIG. 2 is a functional block diagram of a machine tool control device 1 according to the first embodiment. As illustrated in FIG. 2, the machine tool control device 1 according to the first embodiment includes an input unit 11, a condition acquisition unit 12, a surface roughness calculation unit 13, a surface roughness output unit 14, and a surface roughness display unit 15. The machine tool control device 1 is composed of a computer that includes memory such as ROM (read-only memory) and RAM (random access memory), a CPU (control processing unit), and a communication control unit, which are connected to each other via a bus. The functions and operations of each functional unit are achieved by the CPU, memory, and control programs stored in the memory working together in the computer.

The machine tool control device 1 may be composed of a CNC (Computer Numerical Controller) and may be connected to higher-level computers such as a CNC or a PLC (Programmable Logic Controller) (not illustrated). The higher-level computer inputs machining conditions such as rotation speed and feed rate, and oscillation conditions such as oscillation amplitude and oscillation frequency to the machine tool control device 1.

The input unit 11 inputs information on machining conditions and oscillation conditions in response to input operations by an operator using input means (not illustrated), such as a keyboard or a touch panel. The information on machining conditions and oscillation conditions input by the input unit 11 is output to the condition acquisition unit 12, which will be described later.

The condition acquisition unit 12 acquires the machining conditions and oscillation conditions input by the input unit 11. The condition acquisition unit 12 outputs the acquired machining conditions and oscillation conditions to the surface roughness calculation unit 13, which will be described later.

Here, the machining conditions include at least information on the feed amount per relative revolution of the cutting tool and workpiece, and information on the shape of the cutting edge of the cutting tool. For example, the machining conditions also include information such as the rotation number S (l/min) of the spindle, the feed rate (mm/min) of the cutting tool, the workpiece diameter (mm), and the clearance angle (°) of the cutting tool. The information on the feed amount per relative revolution of the cutting tool and workpiece includes the feed amount per revolution F (mm/rev), and the information on the shape of the cutting edge of the cutting tool includes the radius R (mm) of the cutting edge.

The oscillation conditions include information on the number of oscillations per relative revolution of the cutting tool and workpiece, and information on the oscillation amplitude relative to the feed amount per relative revolution of the cutting tool and workpiece. Information on the number of oscillations per relative revolution of the cutting tool and the workpiece includes an oscillation frequency multiplying factor I (times), which indicates the oscillation frequency per revolution of the spindle. Information on the oscillation amplitude relative to the feed amount per relative revolution of the cutting tool and the workpiece includes an oscillation amplitude multiplying factor K (times), which indicates the magnitude of the oscillation amplitude relative to the feed amount per revolution of the spindle. The oscillation frequency multiplying factor I (times) may be specified directly or may be calculated from the oscillation frequency (Hz) and the rotation number S (l/min) of the spindle after specifying the oscillation frequency (Hz). Similarly, the oscillation amplitude multiplying factor K (times) may be specified directly or calculated from the oscillation amplitude (mm), the feed rate (mm/min), and the rotation number S (l/min) of the spindle after specifying the oscillation amplitude (mm).

The surface roughness calculation unit 13 calculates the surface roughness, based on the machining conditions and the oscillation conditions acquired by the condition acquisition unit 12. The surface roughness calculated by the surface roughness calculation unit 13 includes at least one of, for example, the arithmetic average roughness, the maximum height that is the maximum distance between peaks and valleys, the maximum peak height that is the maximum height from the mean line of the surface, the maximum valley depth that is the absolute value of the minimum height from the mean line of the surface, the average height that is the average height of the contour curve elements composed of adjacent peaks and valleys, the maximum cross-sectional height that is the sum of the maximum peak height and maximum valley depth of the contour curve elements, or the bearing length ratio that is the ratio of the bearing length at a predetermined cut level (height % or μm) to the evaluation length of the contour curve elements. The specific method of calculating these parameters of the surface roughness will be described in detail later.

The surface roughness output unit 14 externally outputs the surface roughness calculated by the surface roughness calculation unit 13. In the present embodiment, the surface roughness output unit 14 outputs the calculated surface roughness to the surface roughness display unit 15, which will be described later.

The surface roughness display unit 15 displays the surface roughness output by the surface roughness output unit 14. Specifically, the surface roughness display unit 15 displays the surface roughness calculated by the surface roughness calculation unit 13 on a surface roughness confirmation screen, which will be described in detail later.

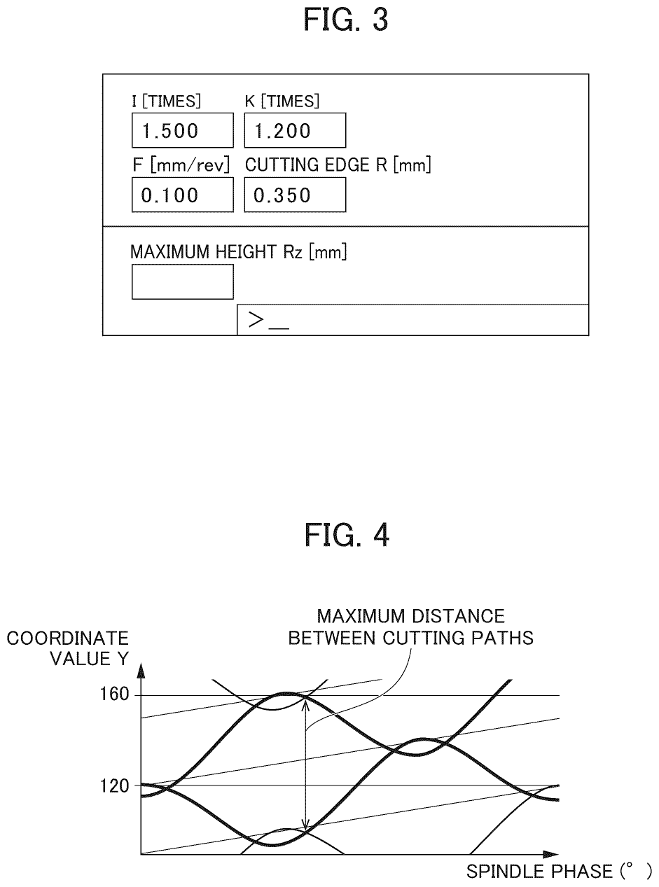

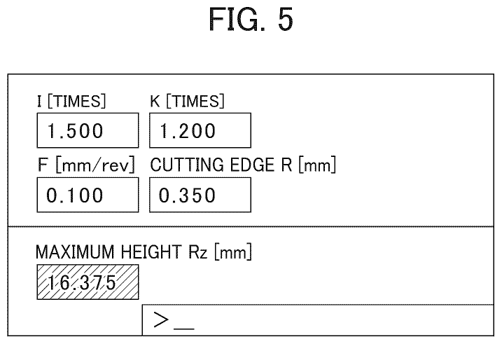

Next, the method of calculating the surface roughness by the surface roughness calculation unit 13 will be described in detail with reference to FIGS. 3 to 5. FIG. 3 is a diagram illustrating a surface roughness confirmation screen where machining conditions and oscillation conditions have been input. FIG. 4 is a diagram illustrating a cutting path. FIG. 5 is a diagram illustrating a surface roughness confirmation screen displaying the calculated surface roughness.

As illustrated in FIG. 3, first, the operator inputs the machining conditions and oscillation conditions by operating the input means of the input unit 11 using the surface roughness confirmation screen of the surface roughness display unit 15. For example, as illustrated in the example in FIG. 3, the operator inputs the oscillation conditions including the feed amount per revolution F (mm/rev) that is the information on the feed amount per relative revolution of the cutting tool and workpiece, and the radius R (mm) of the cutting edge that is the information on the shape of the cutting edge of the cutting tool, and the oscillation conditions including the oscillation frequency multiplying factor I and the oscillation amplitude multiplying factor K.

Then, the condition acquisition unit 12 acquires the input machining conditions and the oscillation conditions, and the surface roughness calculation unit 13 automatically calculates the surface roughness, based on the machining conditions and the oscillation conditions thus acquired. Specifically, the surface roughness calculation unit 13 calculates the coordinate value Y (mm) in the feed direction of the cutting path using the following Formula 1, and searches for the portion where the distance between the cutting paths is the maximum.

$$Formula 1$$

$$Y = \frac{fS}{60} t + \frac{Kf}{2} \{ cos ( 2 π \frac{SI}{60} t ) - 1 \} \qquad FORMULA ( 1 )$$

In Formula 1, Y represents the coordinate value in the feed direction (mm), f represents the feed amount per revolution (mm/rev) of the spindle, S represents the rotation number (l/min) of the spindle, I represents the oscillation frequency multiplying factor (times), K represents the oscillation amplitude multiplying factor (times), and t represents the time (sec).

FIG. 4 illustrates the portion where the distance between the cutting paths is the maximum. In the present embodiment, the coordinate values Y at the portion where the distance between the cutting paths is the maximum are calculated using the above Formula 1, and the distance between the calculated coordinate values is taken as the maximum distance between the cutting paths. For example, when calculating the maximum height Rz that is the maximum distance between the peaks and valleys as the surface roughness, the maximum height Rz can be calculated by substituting the radius R (mm) of the cutting edge and the maximum distance between the cutting paths obtained as described above into the following Formula 2.

$$Formula 2$$

$$Maximum height Rz ( μ m ) = ( maximum distance between cutting paths ) 2 / 8 R \times 1000 \qquad FORMULA ( 2 )$$

Here, in conventional techniques, the surface roughness after oscillation cutting is calculated from machining conditions such as the shape of the cutting edge of the cutting tool, the rotation number of the spindle, and the feed rate. In contrast, as is evident from the above method of calculating surface roughness, the surface roughness calculation unit 13 of the present embodiment calculates the surface roughness based on the calculation conditions including the oscillation conditions, i.e., the oscillation frequency multiplying factor I and the oscillation amplitude multiplying factor K. Therefore, the surface roughness calculation unit 13 of the present embodiment can calculate a more accurate surface roughness, compared to the conventional techniques.

As illustrated in FIG. 5, the surface roughness calculated by the surface roughness calculation unit 13 is automatically displayed on the surface roughness confirmation screen. In FIG. 5, the maximum height is displayed as the surface roughness. This allows the operator to set machining conditions and oscillation conditions while verifying the surface roughness that is calculated more accurately than conventional, allowing for easily setting the machining conditions and oscillation conditions.

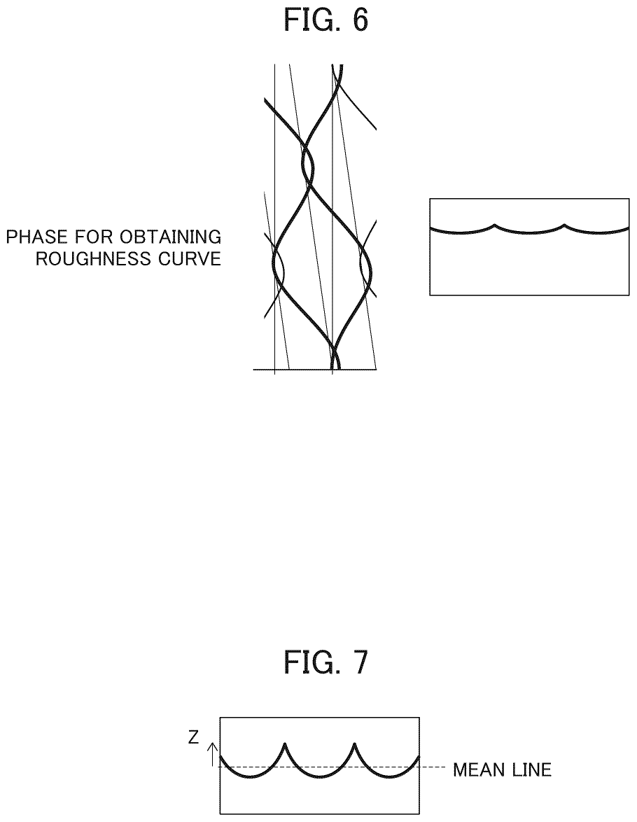

For example, the calculation of the arithmetic average roughness Ra as the surface roughness will be described in detail with reference to FIGS. 6 and 7. FIG. 6 is a diagram illustrating the phase for obtaining the roughness curve. FIG. 7 is a diagram illustrating the roughness curve.

FIG. 6 illustrates the cutting path illustrated in FIG. 4 as rotated 90 degrees, which is an example where the phase at the maximum distance between the cutting paths is taken as the phase for obtaining the roughness curve of the workpiece machining surface. The roughness curve illustrated in FIG. 7 can be obtained by placing an arc of the radius R of the cutting edge at the coordinate values of the cutting path at this phase. In this manner, the roughness curve of the workpiece machining surface can be obtained considering the radius R of the cutting edge of the cutting tool, and the arithmetic average roughness Ra can be calculated by substituting the Z values in the obtained roughness curve in FIG. 7 into the following Formula 3.

$$Formula 3$$

$${R}_{a} = \frac{1}{N} {\sum }_{n = 1}^{N} {Z}_{n} \qquad FORMULA ( 3 )$$

The machine tool control device 1 according to the first embodiment can achieve the following effects.

The machine tool control device 1 according to the present embodiment includes the condition acquisition unit 12 that acquires machining conditions and oscillation conditions, the surface roughness calculation unit 13 that calculates the surface roughness, based on the machining conditions and oscillation conditions, and the surface roughness output unit 14 that outputs the calculated surface roughness. Therefore, while the surface roughness depends upon the machining conditions and oscillation conditions, and it was previously difficult to set machining conditions and oscillation conditions considering the surface roughness, the present embodiment allows for calculating the surface roughness, based on the machining conditions and oscillation conditions, and allows the operator to easily set the machining conditions and oscillation conditions while verifying the surface roughness that has been calculated and externally output.

The machine tool control device 1 according to the present embodiment further includes the surface roughness display unit 15 that displays the surface roughness output by the surface roughness output unit 14. This allows the operator to more easily set machining conditions and oscillation conditions while verifying the surface roughness displayed on the display screen of the surface roughness display unit 15.

The machine tool control device 1 according to the present embodiment acquires the machining conditions including the information on the feed amount per relative revolution of the cutting tool and workpiece, and the information on the shape of the cutting edge of the cutting tool, and the oscillation conditions including the information on the number of oscillations per relative revolution of the cutting tool and workpiece, and the information on the oscillation amplitude relative to the feed amount per relative revolution of the cutting tool and workpiece, and calculates the surface roughness, based on the machining conditions and the oscillation conditions. Therefore, although the surface roughness depends on the oscillation conditions, conventional techniques did not take the oscillation conditions into account. However, the present embodiment can calculate the surface roughness based on the calculation conditions including the oscillation conditions, allowing for calculating a more accurate surface roughness.

### Second Embodiment

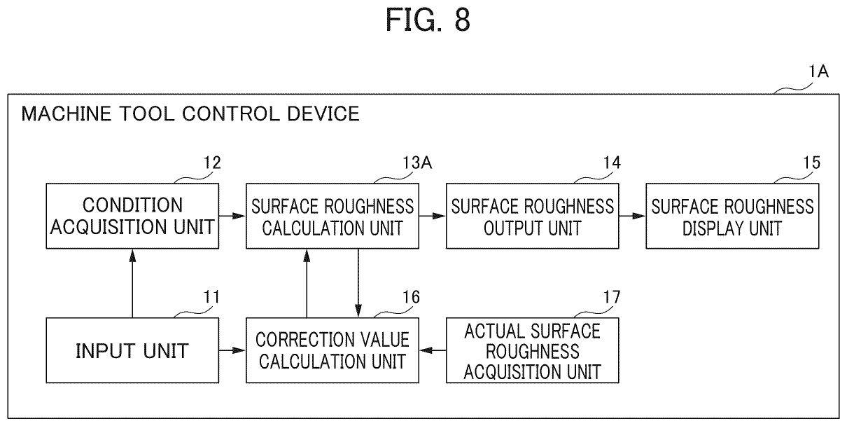

FIG. 8 is a functional block diagram of a machine tool control device 1A according to the second embodiment. As illustrated in FIG. 8, the machine tool control device 1A according to the second embodiment further includes a correction value calculation unit 16 and an actual surface roughness acquisition unit 17, which differs from the machine tool control device 1 according to the first embodiment. Additionally, the surface roughness calculation unit 13A also performs surface roughness correction, which differs from the surface roughness calculation unit 13 of the first embodiment. Other configurations are common to the first embodiment.

The actual surface roughness acquisition unit 17 acquires the actually measured surface roughness of the workpiece machining surface obtained by actually performing oscillation cutting machining. The acquired actual surface roughness is output to the correction value calculation unit 16, which will be described later.

The correction value calculation unit 16 calculates the correction value that is used for correcting the surface roughness. Specifically, the correction value calculation unit 16 calculates the correction value, based on the theoretical surface roughness calculated by the surface roughness calculation unit 13A and the actual surface roughness acquired by the actual surface roughness acquisition unit 17. For example, the correction value calculation unit 16 calculates the correction coefficient or correction amount, based on the deviation multiplying factor or difference between the theoretical surface roughness and the actual surface roughness obtained by actually performing oscillation cutting machining under the machining conditions and oscillation conditions used for calculation. The calculated correction value is output to the surface roughness calculation unit 13A, which will be described later.

The correction value calculation unit 16 preferably calculates correction values for each machining condition. Specifically, the correction value calculation unit 16 preferably calculates correction values for each machining condition, including at least one of the material of the cutting edge of the cutting tool, the shape of the cutting edge of the cutting tool, the material of the workpiece, the cutting speed, the cutting depth, or the cutting angle.

The surface roughness calculation unit 13A calculates the surface roughness, based on the machining conditions and oscillation conditions acquired by the condition acquisition unit 12, using the same calculation method as the one used in the surface roughness calculation unit 13 of the first embodiment. The surface roughness calculation unit 13A corrects the calculated theoretical surface roughness using the correction value calculated by the correction value calculation unit 16, which differs from the surface roughness calculation unit 13 of the first embodiment.

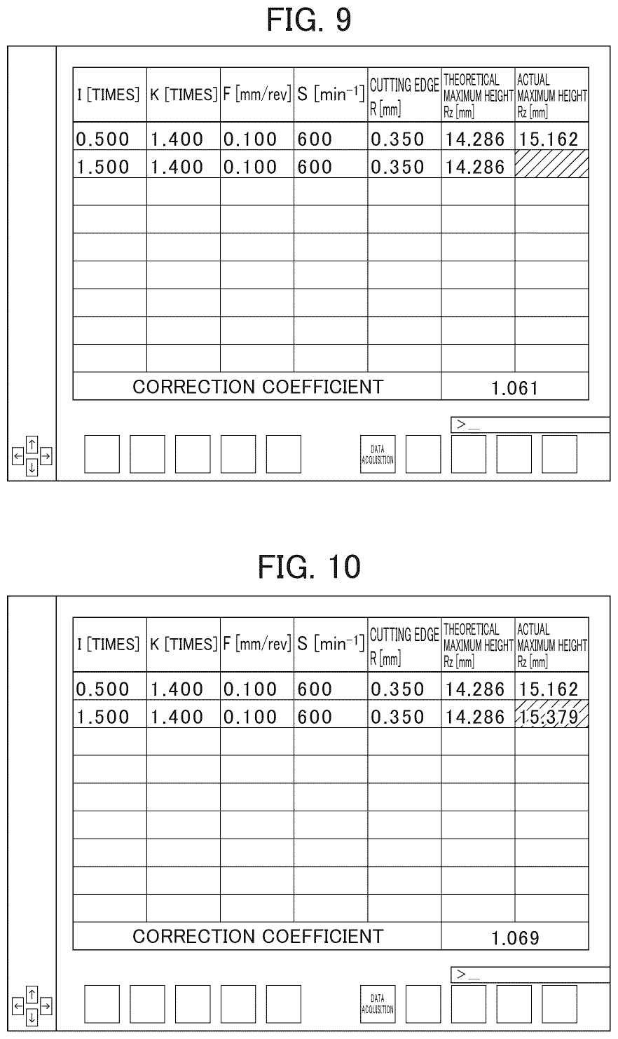

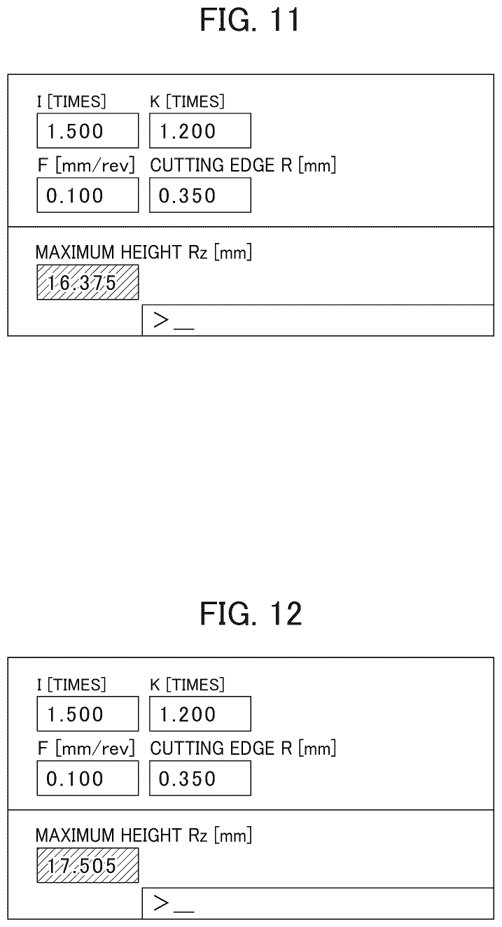

Next, a first example of the surface roughness correction method by the surface roughness calculation unit 13A will be described in detail with reference to FIGS. 9 to 12. FIGS. 9 and 10 are diagrams illustrating the first example of the surface roughness correction table. FIG. 11 is a diagram illustrating a surface roughness confirmation screen displaying the calculated surface roughness. FIG. 12 is a diagram illustrating a surface roughness confirmation screen displaying the surface roughness corrected based on the correction coefficient.

First, the operator inputs the machining conditions including the feed amount per revolution F (mm/rev) that is the information on the feed amount per relative revolution of the cutting tool and workpiece, the radius R (mm) of the cutting edge that is the information on the shape of the cutting edge of the cutting tool, and the rotation number S (l/min) of the spindle, and the oscillation conditions including the oscillation frequency multiplying factor I and the oscillation amplitude multiplying factor K. Then, as illustrated in FIG. 11, the theoretical surface roughness automatically calculated by the surface roughness calculation unit 13A is displayed as the surface roughness on the surface roughness confirmation screen. In FIG. 11, the maximum height Rz is displayed as the surface roughness (the same applies to FIG. 12). The operator operates the machine tool control device 1A before and after the above input operation, and measures the actual surface roughness of the workpiece machining surface obtained by actually performing oscillation cutting machining under the machining conditions and oscillation conditions used for calculating the theoretical surface roughness.

Next, the operator operates the input means of the input unit 11 to open the surface roughness correction table as illustrated in FIG. 9 to correct the calculated theoretical surface roughness. Then, as illustrated in FIG. 9, the surface roughness correction table automatically displays the feed amount per revolution F, the radius R of the cutting edge, the rotation number S of the spindle, the oscillation frequency multiplying factor I, the oscillation amplitude multiplying factor K, and the calculated theoretical surface roughness, which are input on the surface roughness confirmation screen. In FIG. 9, the theoretical maximum height Rz is displayed as the calculated theoretical surface roughness (the same applies to FIG. 10).

Then, the operator operates the input means of the input unit 11 to input the actual surface roughness measured. In FIG. 9, the actual maximum height Rz is displayed as the actual surface roughness (the same applies to FIG. 10). Based on the deviation multiplying factor between the theoretical surface roughness and the actual surface roughness, the correction value calculation unit 16 automatically calculates the correction coefficient. The calculated correction coefficient is automatically displayed in the surface roughness correction table. As illustrated in FIG. 12, the surface roughness displayed on the surface roughness confirmation screen is changed to the value of the surface roughness corrected using the correction coefficient.

As illustrated in FIGS. 9 and 10, if there are a plurality of combinations of machining conditions and oscillation conditions to be input, and there are a plurality of combinations of theoretical surface roughness and actual surface roughness for each combination of conditions, the correction value calculation unit 16 preferably automatically calculates the correction coefficient, based on the arithmetic average of the deviation multiplying factors between the theoretical surface roughness calculated for each combination and the actual surface roughness. Other data analysis methods such as geometric mean, harmonic mean, median, and mode value may also be used for deriving the correction coefficient from the deviation multiplying factor.

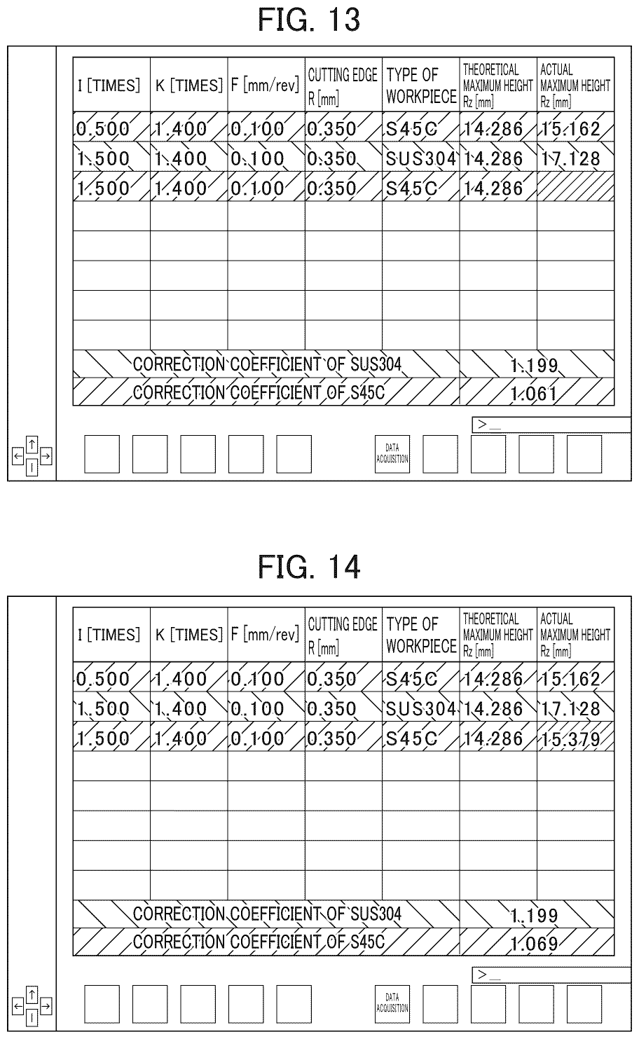

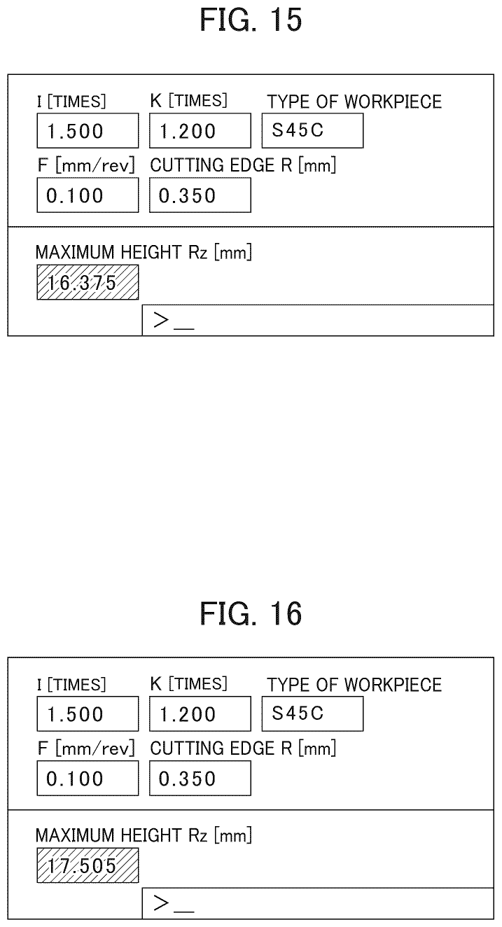

Next, a second example of the surface roughness correction method by the surface roughness calculation unit 13A will be described in detail with reference to FIGS. 13 to 16. FIGS. 13 and 14 are diagrams illustrating the second example of the surface roughness correction table. FIG. 15 is a diagram illustrating a surface roughness confirmation screen displaying the calculated surface roughness. FIG. 16 is a diagram illustrating a surface roughness confirmation screen displaying the surface roughness corrected for each type of workpiece.

First, the operator inputs the machining conditions including the feed amount per revolution F (mm/rev) that is the information on the feed amount per relative revolution of the cutting tool and workpiece, the radius R (mm) of the cutting edge that is the information on the shape of the cutting edge of the cutting tool, and the type (material) of the workpiece, and the oscillation conditions including the oscillation frequency multiplying factor I and the oscillation amplitude multiplying factor K. Then, as illustrated in FIG. 15, the theoretical surface roughness automatically calculated by the surface roughness calculation unit 13A is displayed as the surface roughness on the surface roughness confirmation screen, corresponding to the selected type of workpiece. In FIG. 15, the maximum height Rz is displayed as the surface roughness (the same applies to FIG. 16). The operator by operates the machine tool control device 1A before and after the above input operation, and measures the actual surface roughness of the workpiece machining surface obtained by actually performing oscillation cutting machining under the machining conditions and oscillation conditions used for calculating the theoretical surface roughness.

Next, the operator operates the input means of the input unit 11 to open the surface roughness correction table as illustrated in FIG. 13 to correct the calculated theoretical surface roughness. Then, as illustrated in FIG. 13, the surface roughness correction table automatically displays the feed amount per revolution F, the radius R of the cutting edge, the type of workpiece, the oscillation frequency multiplying factor I, the oscillation amplitude multiplying factor K, and the calculated theoretical surface roughness, which are input on the surface roughness confirmation screen. In FIG. 13, the theoretical maximum height Rz is displayed as the calculated theoretical surface roughness (the same applies to FIG. 14).

Then, the operator operates the input means of the input unit 11 to input the actual surface roughness measured. In FIG. 13, the actual maximum height Rz is displayed as the actual surface roughness (the same applies to FIG. 14). Based on the deviation multiplying factor between the theoretical surface roughness and the actual surface roughness, the correction value calculation unit 16 automatically calculates the correction coefficient. The calculated correction coefficient is automatically displayed in the surface roughness correction table. As illustrated in FIG. 16, the surface roughness displayed on the surface roughness confirmation screen is changed to the value of the surface roughness corrected using the correction coefficient.

As illustrated in FIGS. 13 and 14, the correction coefficient is calculated for each type of workpiece. In the second example, the correction coefficient is calculated for each type of workpiece, but the correction coefficient may also be calculated for each machining condition, including at least one of the material of the cutting edge of the cutting tool, the shape of the cutting edge of the cutting tool, the material of the workpiece, the cutting speed, the cutting depth, or the cutting angle. Similar to the first example, if there are a plurality of combinations of machining conditions and oscillation conditions to be input, and there are a plurality of combinations of theoretical surface roughness and actual surface roughness for each combination, the correction value calculation unit 16 preferably automatically calculates the correction coefficient, based on the arithmetic average of the deviation multiplying factors between the theoretical surface roughness calculated for each combination and the actual surface roughness. Other data analysis methods such as geometric mean, harmonic mean, median, and mode value may also be used for deriving the correction coefficient from the deviation multiplying factor.

The machine tool control device 1A according to the second embodiment can achieve the following effects.

The machine tool control device 1A according to the second embodiment further includes the correction value calculation unit 16 that calculates the correction value used for correcting the surface roughness, and the calculated surface roughness is corrected using the correction value calculated by the correction value calculation unit 16. More specifically, the actual surface roughness acquisition unit 17 that acquires the actual surface roughness obtained by performing the actual machining is further provided, in which the correction value is calculated based on the calculated theoretical surface roughness and the acquired actual surface roughness. This allows for calculating a more accurate surface roughness.

In the machine tool control device 1A according to the second embodiment, the correction value calculation unit 16 calculates the correction value for each machining condition. More specifically, the correction value calculation unit 16 calculates the correction value for each machining condition, including at least one of the material of the cutting edge of the cutting tool, the shape of the cutting edge of the cutting tool, the material of the workpiece, the cutting speed, the cutting depth, or the cutting angle. This allows for calculating an even more accurate surface roughness.

### Third Embodiment

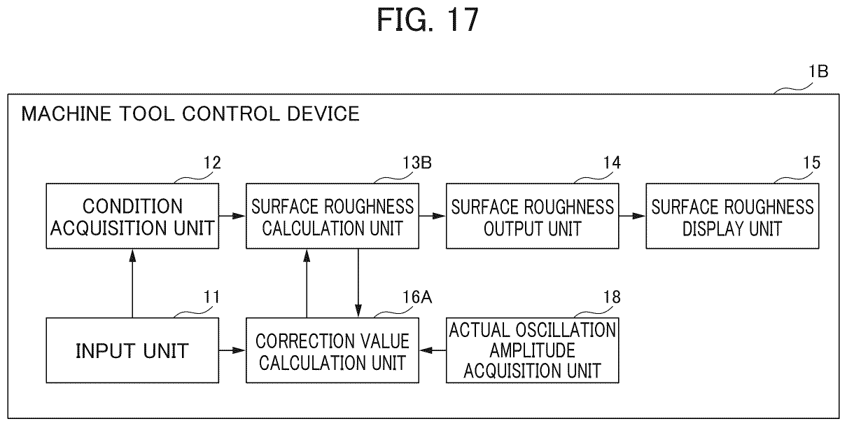

FIG. 17 is a functional block diagram of a machine tool control device 1B according to the third embodiment. As illustrated in FIG. 17, the machine tool control device 1B according to the third embodiment further includes a correction value calculation unit 16A and an actual oscillation amplitude acquisition unit 18, which differs from the machine tool control device 1 according to the first embodiment. Additionally, the surface roughness calculation unit 13B also performs surface roughness correction, which differs from the surface roughness calculation unit 13 of the first embodiment. Other configurations are common to the first embodiment.

The actual oscillation amplitude acquisition unit 18 acquires the actual oscillation amplitude of the cutting path measured by actually performing the oscillation cutting machining under the machining conditions and oscillation conditions used for calculating the theoretical surface roughness. The actual measured value of the cutting path can be acquired with a position detector, such as an encoder, usually provided in the servo motor. The acquired actual oscillation amplitude is output to the correction value calculation unit 16A, which will be described later.

The correction value calculation unit 16A calculates the correction value used for correcting the surface roughness. Specifically, the correction value calculation unit 16A calculates the correction value, based on the attenuation rate of the actual oscillation amplitude acquired by the actual oscillation amplitude acquisition unit 18, relative to the oscillation amplitude acquired by the condition acquisition unit 12, i.e., the command value of the oscillation amplitude. For example, the attenuation rate itself is used as the correction value. The calculated correction value is output to the surface roughness calculation unit 13B, which will be described later.

Similarly to the correction value calculation unit 16 of the second embodiment, the correction value calculation unit 16A preferably calculates the correction value for each machining condition, specifically including at least one of the material of the cutting edge of the cutting tool, the shape of the cutting edge of the cutting tool, the workpiece material, the cutting speed, the cutting depth, or the cutting angle.

The surface roughness calculation unit 13B calculates the theoretical surface roughness, based on the machining conditions and oscillation conditions acquired by the condition acquisition unit 12, using the same calculation method as the one used in the surface roughness calculation unit 13 of the first embodiment. When calculating the surface roughness using Formula 1 using the same calculation method as the one used in the surface roughness calculation unit 13 of the first embodiment, the surface roughness calculation unit 13B calculates the surface roughness by substituting the value obtained by multiplying the oscillation amplitude multiplying factor K by the attenuation rate as the correction value into Formula 1, instead of using the oscillation amplitude multiplying factor K. This allows for calculating the surface roughness corrected based on the attenuation rate.

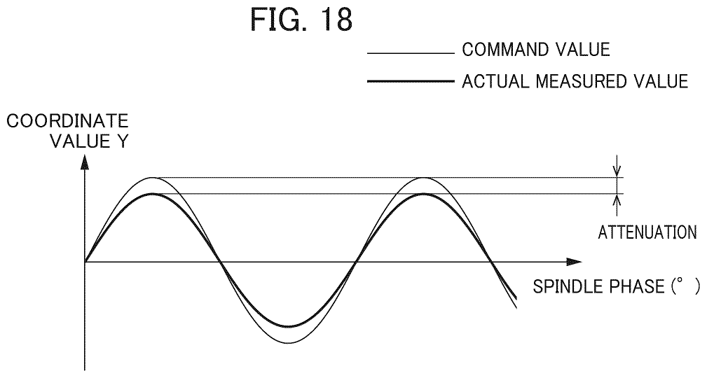

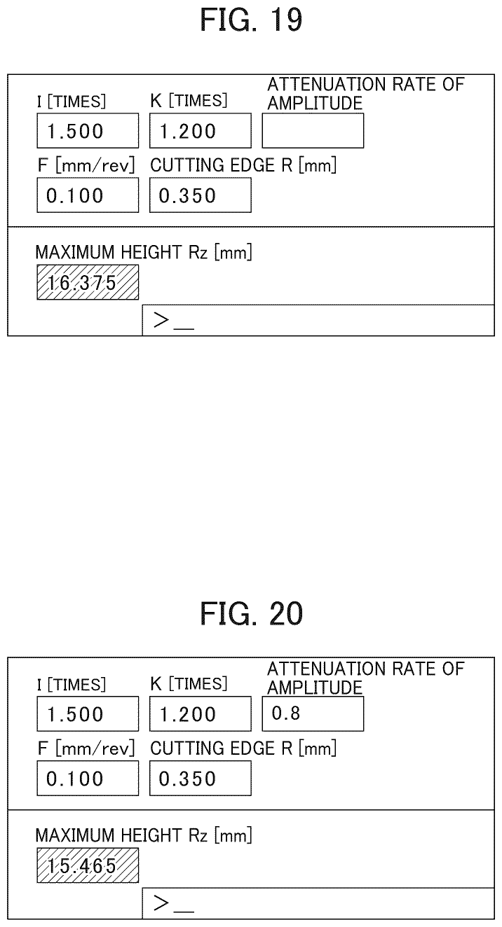

Next, the method of correcting the surface roughness by the surface roughness calculation unit 13B will be described in detail with reference to FIGS. 18 to 20. FIG. 18 is a diagram illustrating the attenuation rate of the actual measured value relative to the command value of the oscillation amplitude. FIG. 19 is a diagram illustrating a surface roughness confirmation screen where the attenuation rate of the oscillation amplitude has been input. FIG. 20 is a diagram illustrating a surface roughness confirmation screen displaying the surface roughness corrected based on the attenuation rate of the oscillation amplitude.

First, the operator inputs the machining conditions including the feed amount per revolution F (mm/rev) that is the information on the feed amount per relative revolution of the cutting tool and workpiece, and the radius R (mm) of the cutting edge that is the information on the shape of the cutting edge of the cutting tool, and the oscillation conditions including the oscillation frequency multiplying factor I and the oscillation amplitude multiplying factor K. Then, as illustrated in FIG. 19, the theoretical surface roughness automatically calculated by the surface roughness calculation unit 13B is displayed as the surface roughness on the surface roughness confirmation screen. In FIG. 19, the maximum height Rz is displayed as the surface roughness (the same applies to FIG. 20). The operator operates the machine tool control device 1A before and after the above input operation, actually performs the oscillation cutting machining using the machining conditions and the oscillation conditions used for calculating the theoretical surface roughness, and obtains the actual measured values of the cutting path.

Next, as illustrated in FIG. 18, the correction value calculation unit 16A calculates the attenuation rate of the actual measured value relative to the command value of the oscillation amplitude by comparing the command value and the actual measured value of the cutting path, and uses the calculated attenuation rate itself as the correction value. Then, the surface roughness calculation unit 13B calculates the surface roughness corrected based on the attenuation rate, and as illustrated in FIG. 20, the surface roughness confirmation screen displays the attenuation rate of the oscillation amplitude, in which the surface roughness displayed is changed to the surface roughness corrected based on the attenuation rate.

The machine tool control device 1B according to the third embodiment can achieve the following effects.

The machine tool control device 1B according to the third embodiment further includes the actual oscillation amplitude acquisition unit 18 that acquires the actual oscillation amplitude obtained by actually performing the oscillation cutting machining, in which the correction value calculation unit 16A calculates the correction value, based on the attenuation rate of the actual oscillation amplitude acquired by the actual oscillation amplitude acquisition unit 18, relative to the oscillation amplitude acquired by the condition acquisition unit 12. This allows for calculating a more accurate surface roughness.

The present disclosure is not limited to the above embodiments, and modifications and improvements that can achieve the object of the present disclosure are included in the present disclosure.

For example, in the second and third embodiments described above, the correction value calculation unit 16, 16A automatically calculates the correction value, but this is not limiting. The operator may manually input and set the correction values obtained by calculation on an external computer, etc.

For example, in the third embodiment described above, if the attenuation rate of the actual oscillation amplitude can be determined from the frequency response of the machine, the correction value may be calculated based on that attenuation rate.

### EXPLANATION OF REFERENCE NUMERALS

1, 1A, 1B: machine tool control device
11: input unit
12: condition acquisition unit
13, 13A, 13B: surface roughness calculation unit
14: surface roughness output unit
15: surface roughness display unit
16, 16A: correction value calculation unit
17: actual surface roughness acquisition unit
18: actual oscillation amplitude acquisition unit

1. A control device for a machine tool that machines a workpiece by relatively oscillating a cutting tool and the workpiece, the control device comprising:
a condition acquisition unit that acquires a machining condition and an oscillation condition;
a surface roughness calculation unit that calculates a surface roughness, based on the machining condition and the oscillation condition acquired by the condition acquisition unit; and
a surface roughness output unit that outputs the surface roughness calculated by the surface roughness calculation unit.

2. The control device for a machine tool according to claim 1, further comprising a surface roughness display unit that displays the surface roughness output by the surface roughness output unit.

3. The control device for a machine tool according to claim 1, wherein the condition acquisition unit acquires
the machining condition including information on a feed amount per relative revolution of the cutting tool and the workpiece, and information on a shape of a cutting edge of the cutting tool, and
the oscillation condition including information on a number of oscillations per relative rotation of the cutting tool and the workpiece, and information on oscillation amplitude relative to a feed amount per relative rotation of the cutting tool and the workpiece.

4. The control device for a machine tool according to claim 1, wherein the surface roughness includes at least one of an arithmetic average roughness, a maximum height, a maximum peak height, a maximum valley depth, an average height, a maximum cross-sectional height, or a bearing length ratio.

5. The control device for a machine tool according to claim 1, further comprising a correction value calculation unit that calculates a correction value used for correcting the surface roughness, wherein
the surface roughness calculation unit corrects the surface roughness calculated based on the machining condition and the oscillation condition acquired by the condition acquisition unit, using the correction value calculated by the correction value calculation unit.

6. The control device for a machine tool according to claim 5, further comprising an actual surface roughness acquisition unit that acquires an actual surface roughness obtained by actually performing the machining, wherein
the correction value calculation unit calculates the correction value, based on the surface roughness calculated by the surface roughness calculation unit and the actual surface roughness acquired by the actual surface roughness acquisition unit.

7. The control device for a machine tool according to claim 5, wherein the correction value calculation unit calculates the correction value, based on an attenuation rate of actual oscillation amplitude relative to oscillation amplitude.

8. The control device for a machine tool according to claim 7, further comprising an actual oscillation amplitude acquisition unit that acquires actual oscillation amplitude obtained by actually performing the machining, wherein
the condition acquisition unit acquires the oscillation amplitude, and
the attenuation rate of the actual oscillation amplitude relative to the oscillation amplitude is calculated based on the oscillation amplitude acquired by the condition acquisition unit and the actual oscillation amplitude acquired by the actual oscillation amplitude acquisition unit.

9. The control device for a machine tool according to claim 5, wherein the correction value calculation unit calculates the correction value for each machining condition.

10. The control device for a machine tool according to claim 9, wherein the correction value calculation unit calculates the correction value for each machining condition, including at least one of a cutting edge material of the cutting tool, a cutting edge shape of the cutting tool, a material of the workpiece, a cutting speed, a cutting depth, or a cutting angle.
